(19) United States
(12) Patent Application Publication
(10) Pub. No.: US 2026/0095482 A1
(43) Pub. Date: Apr. 2, 2026

(54) APPLICATION LAYER SECURITY POLICY IMPLEMENTATION

(71) Applicant: SECURE INDUSTRIES MIDCO, INC., New York, NY (US)

(72) Inventors: Halis Osman Erkan, Istanbul (TR); Murat Demirten, Istanbul (TR)

(21) Appl. No.: 19/111,690

(22) PCT Filed: Sep. 14, 2023
(86) PCT No.: PCT/US2023/074213

§ 371 Date: Mar. 13, 2025

Related U.S. Application Data
(60) Provisional application No. 63/375,581, filed on Sep. 14, 2022.

(51) Int. Cl. H04L 9/40

(52) U.S. Cl. CPC H04L 63/168; H04L 63/20

(57) ABSTRACT

Techniques include using a browser extension to cause a remote cloud controller to query a threat database; the browser extension takes action based on security policies derived from the threat database. The browser extension applies the security policies by determining whether to allow access to a website, block access to the website, alter content of the website, e.g., to block dangerous links and/or prevent phishing attacks, or remove browser isolation. It is noted that the application of the security policy is performed at the application layer rather than at the data link layer or the network layer of the ISO model.

### CROSS REFERENCE TO RELATED APPLICATION

This application claims the benefit of U.S. Provisional Application No. 63/375,581, filed Sep. 14, 2022, the disclosure of which is incorporated herein by reference in its entirety.

### TECHNICAL FIELD

This description relates in general to security policy implementation on a client device.

### SUMMARY

In one general aspect, a method includes receiving, by processing circuitry via an application layer in an Internet browser, a set of uniform resource indicators (URIs), each URI of the set of URIs indicating an address of a website to which a user has requested access. The method also includes sending the set of URIs to a cloud controller external to the processing circuitry, the cloud controller being configured to locate the set of URIs in a threat intelligence database. The method further includes receiving, from the cloud controller, threat intelligence data from the threat intelligence database. The method further includes analyzing a document object model (DOM) of a website associated with the set of URIs according to the threat intelligence data. The method further includes applying a set of security policies to the Internet browser based on the threat intelligence data. The method further includes displaying a rendered browser image on a display for the user according to the set of security policies.

In another general aspect, a computer program product comprising a non-transitory storage medium, the computer program product including code that, when executed by processing circuitry, causes the processing circuitry to perform a method. The method includes receiving, by the processing circuitry via an application layer in an Internet browser, a set of uniform resource indicators (URIs), each URI of the set of URIs indicating an address of a website to which a user has requested access. The method also includes sending the set of URIs to a cloud controller external to the processing circuitry, the cloud controller being configured to locate the set of URIs in a threat intelligence database. The method further includes receiving, from the cloud controller, threat intelligence data from the threat intelligence database. The method further includes analyzing a document object model (DOM) of a website associated with the set of URIs according to the threat intelligence data. The method further includes applying a set of security policies to the Internet browser based on the threat intelligence data. The method further includes displaying a rendered browser image on a display for the user according to the set of security policies.

In another general aspect, an apparatus includes memory and processing circuitry coupled to the memory. The processing circuitry is configured to receive, via an application layer in an Internet browser, a set of uniform resource indicators (URIs), each URI of the set of URIs indicating an address of a website to which a user has requested access. The processing circuitry is also configured to send the set of URIs to a cloud controller external to the processing circuitry, the cloud controller being configured to locate the set of URIs in a threat intelligence database. The processing circuitry is further configured to receive, from the cloud controller, threat intelligence data from the threat intelligence database. The processing circuitry is further configured to analyze a document object model (DOM) of a website associated with the set of URIs according to the threat intelligence data. The processing circuitry is further configured to apply a set of security policies to the Internet browser based on the threat intelligence data. The processing circuitry is further configured to display a rendered browser image on a display for the user according to the set of security policies.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example user device in a network.

FIG. 2 is a diagram that illustrates an example browser window with username and password boxes.

FIG. 3 is a diagram that illustrates an example electronic environment for performing the improved techniques described herein.

FIG. 4 is a flow chart that illustrates an example method of performing encryption according to the improved techniques described herein.

### DETAILED DESCRIPTION

A Secure Web Gateway (SWG) software or hardware has traditionally been used to protect users from Internet or web borne threats such as malware, phishing, malicious website and executable codes. SWGs monitor and inspect by acting on the “man-in-the-middle principle”, and function as a proxy, often uploaded to the cloud, protecting end users from Internet/web borne threats. In order for SWG to provide the said functionality, Internet/web traffic of the end users needs to be tunneled, in other words needs to be moved to SWGs. The data in the traffic moved to the SWGs is decrypted. Then, the decrypted data is inspected to detect potential threats that may be present in traffic in the download-upload directions.

The Internet/web traffic decryption process carried out by SWG to provide services such as URL or URI categorization, threat analysis, virus scanning, malware analysis and protection is called SSL-offloading. Due to the nature of end-point applications such as web browsers, mobile web applications and mobile web browsers, traffic originating from the end-point application (web browser, etc.) is encrypted end-to-end between the end-point application and the responding cloud service. Various algorithms are used for encryption. The SWG must be able to access the key required for decryption and manage the said keys. Therefore, in the said method, encryption keys must be opened to/shared with cloud third parties.

There are various technical problems in the above protection method carried out with the SWG. One of the technical problems is that traffic, whether on a local network or a cloud, must be tunneled/moved to the SWG location via a GRE, VPN, split-VPN or similar transport technology. The necessity to transport traffic to the SWG location puts the SWG in a position of single point of failures and results in a security vulnerability. If a security breach occurs in the SWG location, all keys in the location can be compromised by unauthorized persons. In addition, a need for resources, especially for bandwidth requirement and processing costs for decryption arises. Another one of the problems is the limitations on threat inspection. The context of the data and the data model must be reconstructed for implementing context-and content-based security policies. Reconstruction of the data model of a sophisticated language such as HTML5 can only be achieved by running a web browser again, which means unnecessary cost and serious setbacks in the end user experience. This method is known as DOM mirroring. However, in the SWG method, since all communication is performed in the form of serialized packets, recontextualizing the data and the data model increases the traffic/data load, thereby causing latency. The implementation of context-and content-based security policies, especially for applications sensitive to latency, becomes impractical to implement. Therefore, heuristic analysis approaches are used instead of full content analysis for threat analysis in the SWG approach. The SWG approach, which has to use heuristic analysis for threats due to its network packet level architecture, is insufficient in providing the desired security for many complex scenarios such as mobile devices, distributed workforce or work from home scenarios. The SWG approach, moreover, can produce an excessive amount of false positives and thus overload incident response teams and causing alerts to be missed. Further, the SWG approach can have problems with large files as well as embedded filed within, for example, javascript. All security inspections to be carried out at the data link layer and the network layer (2nd and 3rd layers) according to the ISO model encounter the above problems.

A technical solution to the technical problem includes using a browser extension to cause a remote cloud controller to query a threat intelligence database; the browser extension takes action based on security policies derived from threat intelligence data from the threat intelligence database and real-time analysis of a document object model (DOM) of a website. The browser extension applies the security policies by determining whether to allow access to a website, block access to the website, alter content of the website, e.g., to block dangerous links and/or prevent phishing attacks, or remove browser isolation. It is noted that the application of the security policy is performed at the application layer rather than at the data link layer or the network layer of the ISO model.

Advantageously, the technical solution involves performing threat protection without transferring the data traffic to a cloud medium, requiring no tunneling. In addition, when the traffic is not transferred to a cloud medium, the requirement of transferring the keys necessary to decrypt the data to the external environment/cloud is eliminated and the problem of security vulnerability caused by the creation of a single point of failure is prevented. Moreover, since the traffic is not transferred to a cloud medium, bandwidth and process costs are lowered compared to conventional techniques.

It is noted that the threat intelligence data explains known attack patterns and is useful in stopping such known threats. It is further noted that the real-time analysis of the DOM may be used to stop further attacks that are not part of the threat intelligence data and may form part of zero-day attacks. Based on both the threat intelligence data and the real-time DOM analysis,

It is also noted that, by “real-time,” it is meant that the analysis is performed while requested website content is being loaded. For example, when a user issues a request for website content, the DOM of the website is analyzed before any content is displayed to the user. In this way, decisions about what may be displayed in the browser window may be made before any potentially harmful material is made available to the user. In this way, the DOM of a website is analyzed continuously in case there are any changes to the DOM sent by the remote server operating the website.

It is further noted that the threat intelligence data provides information about known threats, while the real-time analysis of the DOM provides information about threats that may not be known, such as zero-day threats.

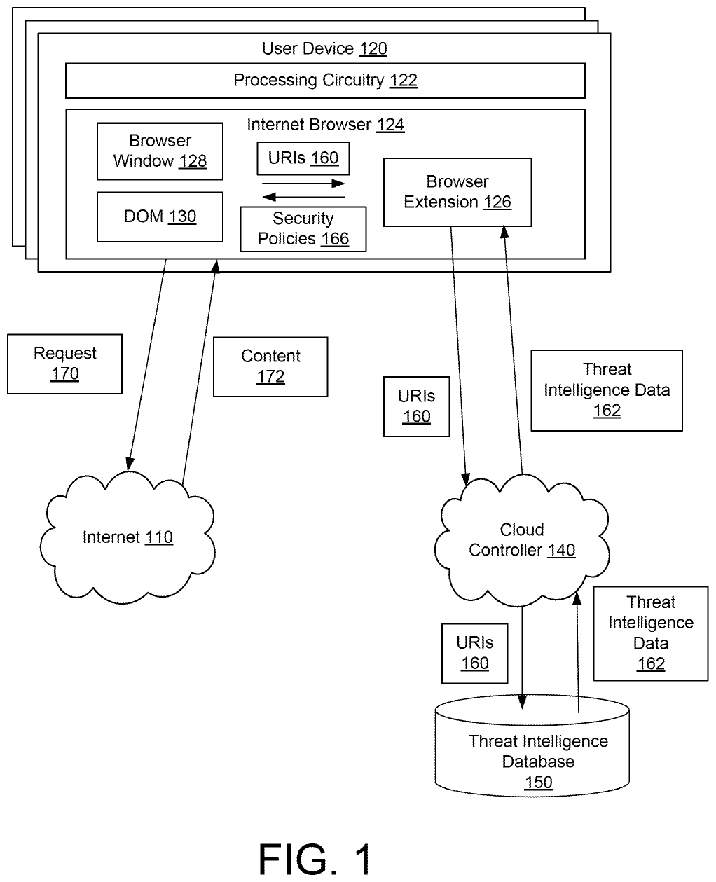

FIG. 1 is a diagram that illustrates an example user device 120 in a network. The user device 120 can be a personal computer, laptop, smartphone, tablet computer, or the like. As shown in FIG. 1, the user device 120 includes processing circuitry 122 which runs an Internet browser 124.

The Internet browser 124 is configured to receive a request 170 to access a website, send the request 170 out to a server, and receive content 172 from the server. The request 170 may include a uniform resource identifier (URI) that provides an address of the server with the content 172.

The Internet browser 124, as shown in FIG. 1, includes a browser extension 126, a browser window 128, and a document object model (DOM) 130 of a website viewed in the browser window 128. The browser window 128 is configured to display the content of the Internet browser 124 on a display of the user device 120 according to security policies derived by the browser extension 126. The browser extension 126 is configured to derive security policies 166 based on threat intelligence data 162 from a threat intelligence database 150 and implement those security policies in the Internet browser 124. The DOM 130 of a website represents the website in the Internet browser 124, including what is displayed in the browser window 128 and what commands are executed in the Internet browser 124.

The threat intelligence database 150 contains information about threats posed by URIs, e.g., URIs 160. The URIs 160 are, in some implementations, a result of hooking a network request loop, e.g., gathering all possible ways to reach a destination. The browser extension 126 is configured to send the URIs 160 to a cloud controller 140 external to the user device 120 (and hence external to the processing circuitry 122). The cloud controller 140 is configured to perform queries of the threat intelligence database 150 from the URIs 160, receive threat intelligence data 162 from the threat intelligence database 150, and send the threat intelligence data 162 back to the browser extension 126.

The browser extension 126 is configured to request the network request loop in the Internet browser 124 via an application programming interface (API) and to hook the network request loop. The browser extension 126 is also configured to receive all URIs 160 to be visited and rendered from the relevant function in the hooked network request loop. The browser extension 126 is further configured to insert a document object model (DOM) of all URIs 160 to be rendered from the relevant function in the hooked network request loop.

The browser extension 126, upon receiving the threat intelligence data 162, is configured to derive security policies 166 from the threat intelligence data 162. The security policies include, in some implementations, allowing the content 172, blocking the content 172, render the content 172 as read-only, remove a browser isolation. Moreover, depending on the threat intelligence data 162, the browser extension can perform other operations on the content 172 such as disabling a data input field such as a password entry box and/or a username entry box.

In particular, the browser extension 126 is configured to analyze the DOM 130 of a website associated with the URIs 160 according to the threat intelligence data 162. This analysis is performed in real time so that action may be taken against the content 172 if it is deemed that the content 172 contains threats according to the threat intelligence data 162.

The browser extension 126 is configured to generate a content script to implement the security policies 166. In some implementations, the browser extension 126 implements the security policies 166 by inserting the content scripts into a document object model (DOM), which represents the content 172 associated with a URI (e.g., URIs 170).

The browser 124 is then configured to render the content 170 according to the DOM, e.g., with the content scripts, and display the rendered content in the browser window 128 on a display of the user device 120.

In some implementations, the operation of hooking the network request loop is performed with standard hooking methods provided by at least one extension in the web/internet browser by means of the w3c standard. In such an implementation, the relevant function in the hooked network request loop, where preferably all the uniform resource identifiers (URIs) to be visited and rendered are received, is an “onBeforeRequest” function. This function is used as a trigger denoting that the end user has interacted with a document object model (DOM) representing website content 172 in the Internet browser 124.

In some implementations, the relevant function in the hooked network request loop, in which the DOM of all URIs 170 to be rendered is received, is an “externally_connectable” function.

In some implementations, the browser extension 126 is configured to allow the security content scripts, which will attach themselves to the DOM within each session, to interfere with the original source code of the visited website. Security javascripts communicate with cloud databases, actively overriding the risky functions on the rendered DOM at that time. Examples of risky functions include input fields or risky cross-site scripts. Depending on a risk perception, some fields can be blocked automatically or additional policy controls can be carried out over the cloud if action is taken.

In some implementations, the DOM of all URIs 170 is inserted continuously. Most web pages that can be requested have a dynamic structure. Therefore, the DOM can also change dynamically. Continuously monitoring and saving the document object model (DOM) allows to adapt to the dynamic change and render the selected security policies to the live/real time DOM. The important distinction here is that another copy of the DOM is not made, but it is performed on the DOM, which is compiled in real-time in the Internet browser 124.

In some implementations, the browser extension 126 is replaced with a plug-in (e.g., an Internet browser plug-in) or a piece of code embedded in the Browser 124.

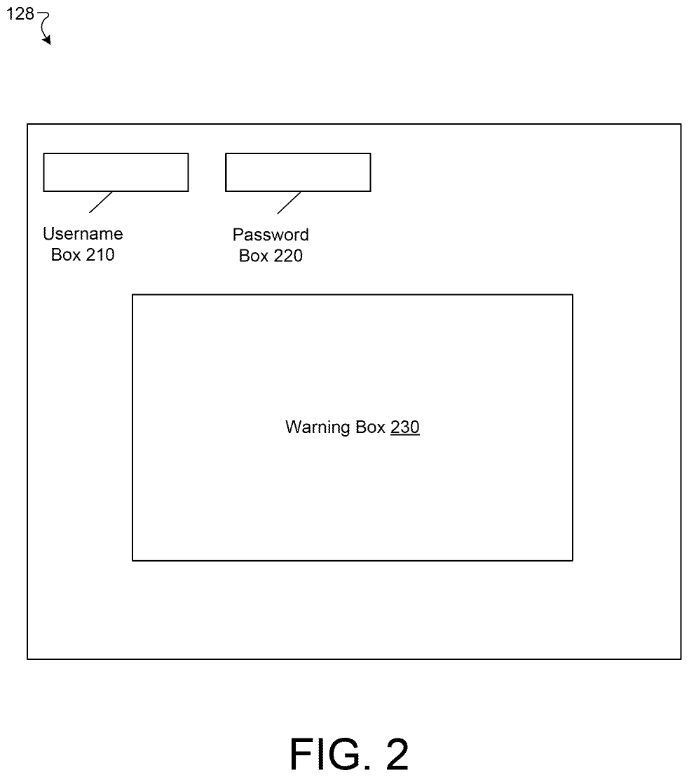

In some implementations, the browser extension 126 is configured to disable a data input field or insert a selected object into the DOM. Blocking a password entry in a password entry box is an example for disabling the data input field. Implementing a read-only browsing mode where keyboard keystrokes and mouse gestures are prevented is an example for inserting a selected object into the document object model (DOM). An example of a disabled data input field is shown in FIG. 2.

FIG. 2 is a diagram that illustrates an example browser window 128 with username and password boxes 210 and 220, respectively. Under conventional operation, a user inputs a username in the username box 210 and a password in the password box 220 in order to, e.g., log into a website. Nevertheless, some websites may be generated by a malicious actor for phishing in order to obtain the username and password of the user.

Depending on the threat intelligence data 162 (FIG. 1) and real-time analysis of the DOM 130, the browser extension 126 can insert a security content script into the DOM that affects the behavior of the username box 210 and/or the password box 220. For example, if the threat intelligence data 162 indicates that the requested website has no known threat, then the browser extension 126 preserves the functionality of the username box 210 and the password box 220. If, however, the threat intelligence data 162 indicates that the requested website is associated with a known threat such as being a phishing site, then the browser extension 126 generates a security content script that disables the username box 210 and/or the password box 220.

In some implementations, if the threat intelligence data 162 indicates a low to middle level of risk, the browser extension 126 implements a warning box 230 that provides a warning to the user that there is a risk of entering a username and/or a password in the respective boxes 210, 220.

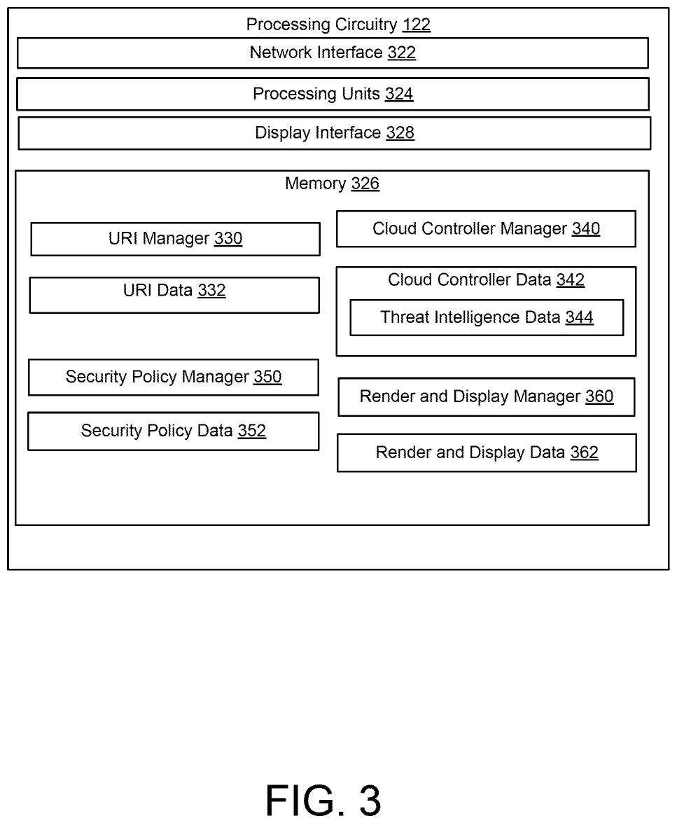

FIG. 3 is a diagram illustrating an example electronic environment for implementing security policies at the application layer. As shown in FIG. 3, the processing circuitry 122 includes a network interface 322, one or more processing units 324, nontransitory memory (storage medium) 326, and a display interface 328.

In some implementations, one or more of the components of the processing circuitry 122 can be, or can include processors (e.g., processing units 324) configured to process subroutines stored in the memory 326 as a computer program product. Examples of such subroutines as depicted in FIG. 3 include URI manager 330, cloud controller manager 340, security policy manager 350, and render and display manager 360. Further, as illustrated in FIG. 2, the memory 326 is configured to store various data, which is described with respect to the respective services and managers that use such data.

The URI manager 330 is configured to receive URIs (URI data 332) to be visited as part of a request to access a website from a user. The URIs to be visited are rendered from a relevant function in a hooked network request loop. In some implementations, the relevant function is an “onBeforeRequest” function. In some implementations, the relevant function is an “externally_connectable”function.

The cloud controller manager 340 is configured to send the URIs represented in URI data 332 to a cloud controller for lookup in a threat intelligence database. The cloud controller manager 340 is also configured to receive threat intelligence data 344 (included in cloud controller data 342) from the threat intelligence database regarding the URIs sent to the cloud controller.

The security policy manager 350 is configured to implement security policies in the Internet browser based on the threat intelligence data 344. In some implementations, the security policy manager 350 is configured to generate a content script and insert the content script in a document object model (DOM) of all URIs to be rendered from the relevant function in the hooked network request loop. The content script is, in some implementations, javascript code that is inserted in the DOM. For example, a content script generated by the security policy manager 350 and inserted in the DOM may be configured to disable a data input box such as a password box.

The render and display manager 360 is configured to render content according to the set of security policies (e.g., according to the content script inserted in the DOM of all URIs to be rendered from the relevant function in the hooked network request loop). The render and display manager 360 is also configured to display the rendered content on a display of a user device in a browser window.

The components (e.g., modules, processing units 324) of processing circuitry 122 can be configured to operate based on one or more platforms (e.g., one or more similar or different platforms) that can include one or more types of hardware, software, firmware, operating systems, runtime libraries, and/or so forth. In some implementations, the components of the processing circuitry 122 can be configured to operate within a cluster of devices (e.g., a server farm). In such an implementation, the functionality and processing of the components of the processing circuitry 122 can be distributed to several devices of the cluster of devices.

The components of the processing circuitry 122 can be, or can include, any type of hardware and/or software configured to implement security policies at the application layer. In some implementations, one or more portions of the components shown in the components of the processing circuitry 122 in FIG. 3 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 122 can be, or can include, a software module configured for execution by at least one processor (not shown) to cause the processor to perform a method as disclosed herein. In some implementations, the functionality of the components can be included in different modules and/or different components than those shown in FIG. 3, including combining functionality illustrated as two components into a single component.

The network interface 322 includes, for example, wireless adaptors, and the like, for converting electronic and/or optical signals received from the network to electronic form for use by the processing circuitry 122. The set of processing units 324 include one or more processing chips and/or assemblies. The memory 326 includes both volatile memory (e.g., RAM) and non-volatile memory, such as one or more ROMs, disk drives, solid state drives, and the like. The set of processing units 324 and the memory 326 together form part of the processing circuitry 122, which is configured and arranged to carry out various methods and functions as described herein.

Although not shown, in some implementations, the components of the processing circuitry 122 (or portions thereof) can be configured to operate within, for example, a data center (e.g., a cloud computing environment), a computer system, one or more server/host devices, and/or so forth. In some implementations, the components of the processing circuitry 122 (or portions thereof) can be configured to operate within a network. Thus, the components of the processing circuitry 122 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the processing circuitry 220 can be, or can include, processors configured to process instructions stored in a memory. For example, URI manager 330 (and/or a portion thereof), cloud controller manager 340 (and/or a portion thereof), security policy manager 350 (and/or a portion thereof), and render and display manager 360 (and/or a portion thereof) are examples of such instructions.

In some implementations, the memory 326 can be any type of memory such as a random-access memory, a disk drive memory, flash memory, and/or so forth. In some implementations, the memory 326 can be implemented as more than one memory component (e.g., more than one RAM component or disk drive memory) associated with the components of the processing circuitry 122. In some implementations, the memory 326 can be a database memory. In some implementations, the memory 326 can be, or can include, a non-local memory. For example, the memory 326 can be, or can include, a memory shared by multiple devices (not shown). In some implementations, the memory 326 can be associated with a server device (not shown) within a network and configured to serve the components of the processing circuitry 122. As illustrated in FIG. 2, the memory 326 is configured to store various data, including URI data 332, cloud controller data 342, security policy data 352, and render and display data 362.

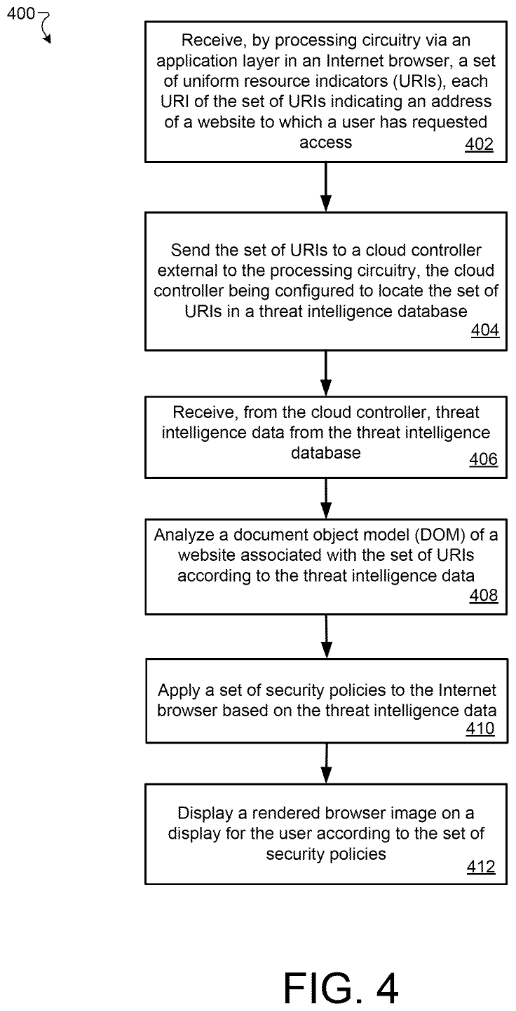

FIG. 4 is a flow chart illustrating an example method 400 for implementing security policies at the application layer. The method 400 may be performed using the processing circuitry 122 of FIGS. 1 and 3.

At 402, the URI manager 330 (FIG. 3) receives, by processing circuitry via an application layer in an Internet browser, a set of uniform resource indicators (URIs), each URI of the set of URIs indicating an address of a website to which a user has requested access.

At 404, the cloud controller manager 340 sends the set of URIs to a cloud controller external to the processing circuitry, the cloud controller being configured to locate the set of URIs in a threat intelligence database.

At 406, the cloud controller manager 340 receives, from the cloud controller, threat intelligence data from the threat intelligence database.

At 408, the security policy manager 350 analyzes a document object model (DOM) of a website associated with the set of URIs according to the threat intelligence data.

At 410, the security policy manager 350 applies a set of security policies to the Internet browser based on the threat intelligence data.

At 412, the render and display manager 360 displays a rendered browser image on a display for the user according to the set of security policies.

Although the disclosed concepts include those defined in the attached claims, it should be understood that the concepts can also be defined in accordance with the following examples.
Example 1 is a method comprising: receiving, by processing circuitry via an application layer in an Internet browser, a set of uniform resource indicators (URIs), each URI of the set of URIs indicating an address of a website to which a user has requested access; sending the set of URIs to a cloud controller external to the processing circuitry, the cloud controller being configured to locate the set of URIs in a threat intelligence database; receiving, from the cloud controller, threat intelligence data from the threat intelligence database; analyzing a document object model (DOM) of a website associated with the set of URIs according to the threat intelligence data; applying a set of security policies to the Internet browser based on the threat intelligence data; and displaying a rendered browser image on a display for the user according to the set of security policies.
Example 2 is the method of Example 1, wherein the set of security policies include at least one of block, allow, render read-only, remove browser isolation, or alternate content of the website via the DOM to at least one of remove or disable content that potentially includes threats.
Example 3 is the method of any of Examples 1 to 2, further comprising performing a hooking operation on a network request loop to produce a hooked network request loop, the set of URIs being rendered from a relevant function of the hooked network request loop.
Example 4 is the method of Example 3, wherein the hooking operation is performed with a standard hooking technique of at least one extension in the Internet browser.
Example 5 is the method of any of Examples 3 to 4, wherein the relevant function is an onBeforeRequest function.
Example 6 is the method of any of Examples 3 to 4, wherein the relevant function is an externally_connectable function.
Example 7 is the method of any of Examples 3 to 6, wherein applying the set of security policies includes inserting, via at least one content script, the set of security policies into the DOM.
Example 8 is the method of Example 3, wherein the DOM is continuously inserted into the network request loop.
Example 9 is the method of any of Examples 1 to 8, wherein applying the set of security policies includes disabling a data input field of the Internet browser.
Example 10 is the method of Example 9, wherein the data input field includes a password entry box.
Example 11 is a security policy implementation method comprising:
   requesting a network request loop in an Internet browser via an application programming interface (API) and hooking the network request loop; receiving all uniform resource identifiers (URIs) to be visited and rendered from a relevant function in the hooked network request loop; sending the URIs for inspection with a risk intelligence information in a threat intelligence database present in a cloud controller; inserting a document object model (DOM) of all URIs to be rendered from the relevant function in the hooked network request loop; attaching selected security policies to the DOM via content scripts supported as a w3c standard; rendering of a page image by the Internet browser with the DOM; and displaying the page image to a user in a browser window.
Example 12 is the security policy implementation method of Example 11, further comprising performing the hooking of the network request loop with standard hooking methods of at least one extension in the Internet browser.
Example 13 is the security policy implementation method of Example 12, wherein the relevant function in the hooked network request loop, where all the URIs to be visited and rendered are received, is an “onBeforeRequest”function.
Example 14 is the security policy implementation method of Example 12, wherein the relevant function in the hooked network request loop, where the DOM of all URIs to be rendered is received, is an “externally_connectable”function.
Example 15 is the security policy implementation method of any of the preceding Examples, further comprising continuously inserting a document object model (DOM) of all URIs.
Example 16 is the security policy implementation method of any of the preceding Examples, further comprising disabling a data input field of selected security policies and/or inserting a selected object into a document object model (DOM).
Example 17 is the security policy implementation method of Example 16, further comprising disabling the data input field in the form of blocking a password entry in a password entry box.
Example 18 is the security policy implementation method of any of Examples 16 to 17, further comprising inserting the selected object into the DOM in the form of implementing a read-only browsing mode where keyboard keystrokes and mouse gestures are prevented.
Example 19 is an extension, a plug-in, an Internet browser application, or a piece of code embedded in an Internet browser application, wherein a security policy implementation of any of Examples 11 to 18 is executed.
Example 20 is a security policy implementation system including at least one client application executable in at least one processer comprising a security policy implementation method of any of Examples 11 to 18.
Example 21 is a nontransitory computer-readable storage medium including at least one client application executable in at least one processor comprising a security implementation method of any of examples 11-18.
Example 22 is a computer program product comprising a nontransitive storage medium, the computer program product including code that, when executed by processing circuitry, causes the processing circuitry to perform a method, the method comprising: receiving, by processing circuitry via an application layer in an Internet browser, a set of uniform resource indicators (URIs), each URI of the set of URIs indicating an address of a website to which a user has requested access; sending the set of URIs to a cloud controller external to the processing circuitry, the cloud controller being configured to locate the set of URIs in a threat intelligence database; receiving, from the cloud controller, threat intelligence data from the threat intelligence database; analyzing a document object model (DOM) of a website associated with the set of URIs according to the threat intelligence data; applying a set of security policies to the Internet browser based on the threat intelligence data; and displaying a rendered browser image on a display for the user according to the set of security policies.
Example 23 is the computer program product of Example 22, wherein the set of security policies include at least one of block, allow, render read-only, remove browser isolation, or alternate content of the website via the DOM to at least one of remove or disable content that potentially includes threats.
Example 24 is the computer program product of any of Examples 22 to 23, wherein the method further comprises performing a hooking operation on a network request loop to produce a hooked network request loop, the set of URIs being rendered from a relevant function of the hooked network request loop.
Example 25 is the computer program product of Example 24, wherein the hooking operation is performed with a standard hooking technique of at least one extension in the Internet browser.
Example 26 is the computer program product of any of Examples 24 to 25, wherein the relevant function is an onBeforeRequest function.
Example 27 is the computer program product of any of Examples 24 to 25, wherein the relevant function is an externally_connectable function.
Example 28 is the computer program product of any of Examples 24 to 27, wherein applying the set of security policies includes inserting, via at least one content script, the set of security policies into the DOM.
Example 29 is the computer program product of Example 24, wherein the DOM is continuously inserted into the network request loop.
Example 30 is the computer program product of any of Examples 22 to 29, wherein applying the set of security policies includes disabling a data input field of the Internet browser.
Example 31 is the computer program product of Example 30, wherein the data input field includes a password entry box.
Example 32 is an electronic apparatus comprising memory and processing circuitry coupled to the memory, the processing circuitry being configured to: receive, via an application layer in an Internet browser, a set of uniform resource indicators (URIs), each URI of the set of URIs indicating an address of a website to which a user has requested access; send the set of URIs to a cloud controller external to the processing circuitry, the cloud controller being configured to locate the set of URIs in a threat intelligence database; receive, from the cloud controller, threat intelligence data from the threat intelligence database; analyze a document object model (DOM) of a website associated with the set of URIs according to the threat intelligence data; apply a set of security policies to the Internet browser based on the threat intelligence data; and display a rendered browser image on a display for the user according to the set of security policies.
Example 33 is the electronic apparatus of Example 32, wherein the set of security policies include at least one of block, allow, render read-only, remove browser isolation, or alternate content of the website via the DOM to at least one of remove or disable content that potentially includes threats.
Example 34 is the electronic apparatus of any of Examples 32 to 33, wherein the processing circuitry is further configured to perform a hooking operation on a network request loop to produce a hooked network request loop, the set of URIs being rendered from a relevant function of the hooked network request loop.
Example 35 is the electronic apparatus of Example 34, wherein the hooking operation is performed with a standard hooking technique of at least one extension in the Internet browser.
Example 36 is the electronic apparatus of any of Examples 34 to 35, wherein the relevant function is an onBeforeRequest function.
Example 37 is the electronic apparatus of any of Examples 34 to 35, wherein the relevant function is an externally_connectable function.
Example 38 is the electronic apparatus of any of Examples 34 to 37, wherein the processing circuitry configured to apply the set of security policies is further configured to insert, via at least one content script, the set of security policies into the DOM.
Example 39 is the electronic apparatus of Example 34, wherein the DOM is continuously inserted into the network request loop.
Example 40 is the electronic apparatus of any of Examples 32 to 39, wherein the processing circuitry configured to apply the set of security policies is further configured to disable a data input field of the Internet browser.

Example 41 is the electronic apparatus of Example 40, wherein the data input field includes a password entry box.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A method, comprising:
receiving, by processing circuitry via an application layer in a browser, a set of uniform resource indicators (URIs), each URI of the set of URIs indicating an address of a website to which a user has requested access;
sending the set of URIs to a cloud controller external to the processing circuitry, the cloud controller being configured to locate the set of URIs in a threat intelligence database;
receiving, from the cloud controller, threat intelligence data from the threat intelligence database;
analyzing a document object model (DOM) of a website associated with the set of URIs according to the threat intelligence data;
applying a set of security policies to the browser based on the threat intelligence data; and
displaying a rendered browser image on a display for the user according to the set of security policies.

2. The method as in claim 1, wherein the set of security policies include at least one of block, allow, render read-only, remove browser isolation, or alternate content of the website via the DOM to at least one of remove or disable content that potentially includes threats.

3. The method as in claim 1, further comprising:
performing a hooking operation on a network request loop to produce a hooked network request loop, the set of URIs being rendered from a relevant function of the hooked network request loop.

4. The method as in claim 3, wherein the hooking operation is performed with a standard hooking technique of at least one extension in the browser.

5. The method as in claim 3, wherein the relevant function is an onBeforeRequest function.

6. The method as in claim 3, wherein the relevant function is an externally_connectable function.

7. The method as in claim 3, wherein applying the set of security policies includes:
inserting, via at least one content script, the set of security policies into the DOM.

8. The method as in claim 3, wherein the DOM is continuously inserted into the network request loop.

9. The method as in claim 1, wherein applying the set of security policies includes:
disabling a data input field of the browser.

10. The method as in claim 9, wherein the data input field includes a password entry box.

11. A computer program product comprising a nontransitive storage medium, the computer program product including code that, when executed by processing circuitry, causes the processing circuitry to perform a method, the method comprising:
receiving, by the processing circuitry via an application layer in a browser, a set of uniform resource indicators (URIs), each URI of the set of URIs indicating an address of a website to which a user has requested access;
sending the set of URIs to a cloud controller external to the processing circuitry, the cloud controller being configured to locate the set of URIs in a threat intelligence database;
receiving, from the cloud controller, threat intelligence data from the threat intelligence database;
analyzing a document object model (DOM) of a website associated with the set of URIs according to the threat intelligence data;
applying a set of security policies to the browser based on the threat intelligence data; and
displaying a rendered browser image on a display for the user according to the set of security policies.

12. The computer program product as in claim 11, wherein the set of security policies include at least one of block, allow, render read-only, remove browser isolation, or alternate content of the website via the DOM to at least one of remove or disable content that potentially includes threats.

13. The computer program product as in claim 11, wherein the method further comprises:
performing a hooking operation on a network request loop to produce a hooked network request loop, the set of URIs being rendered from a relevant function of the hooked network request loop.

14. The computer program product as in claim 13, wherein applying the set of security policies includes:
inserting, via at least one content script, the set of security policies into the DOM.

15. The computer program product as in claim 11, wherein applying the set of security policies includes:
disabling a data input field of the browser.

16. An electronic apparatus, the electronic apparatus comprising:
memory; and
processing circuitry coupled to the memory, the processing circuitry being configured to:
receive, via an application layer in a browser, a set of uniform resource indicators (URIs), each URI of the set of URIs indicating an address of a website to which a user has requested access;
send the set of URIs to a cloud controller external to the processing circuitry, the cloud controller being configured to locate the set of URIs in a threat intelligence database;
receive, from the cloud controller, threat intelligence data from the threat intelligence database;
analyze a document object model (DOM) of a website associated with the set of URIs according to the threat intelligence data;
apply a set of security policies to the browser based on the threat intelligence data; and
display a rendered browser image on a display for the user according to the set of security policies.

17. The electronic apparatus as in claim 16, wherein the set of security policies include at least one of block, allow, render read-only, remove browser isolation, or alternate content of the website via the DOM to at least one of remove or disable content that potentially includes threats.

18. The electronic apparatus as in claim 16, wherein the processing circuitry is further configured to:
perform a hooking operation on a network request loop to produce a hooked network request loop, the set of URIs being rendered from a relevant function of the hooked network request loop.

19. The electronic apparatus as in claim 18, wherein the processing circuitry configured to apply the set of security policies is further configured to:
insert, via at least one content script, the set of security policies into the DOM.

20. The electronic apparatus as in claim 16, wherein the processing circuitry configured to apply the set of security policies is further configured to:
disable a data input field of the browser.
